(19) United States
(12) Patent Application Publication
(10) Pub. No.: US 2007/0217430 A1
(43) Pub. Date: Sep. 20, 2007

(54) Method and system for initiating communications

(75) Inventors: Randall B. Baird, Austin, TX (US); Parameswaran Kumarasamy, San Jose, CA (US); Manjunath S. Bangalore, San Jose, CA (US); Ryan M. Knotts, Sunnyvale, CA (US); Kannan Murali, Fremont, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/385,347

(22) Filed: Mar. 20, 2006

(51) Int. Cl. H04L 12/56

(52) U.S. Cl. 370/395.52

(57) ABSTRACT

According to one embodiment of the invention, a method for use in establishing communications includes receiving an invitation for communication at a first device. The invitation for communication is devoid of video capability information. In response to receiving the invitation for communication, the method includes transmitting, from the first device, a signal other than an SDP signal. This signal includes video capability information. After transmission of the signal, the first device receives an offer and incorporates the video capability information included in the signal.

### TECHNICAL FIELD OF THE INVENTION

This invention relates generally to initiating communications and more particularly to initiating Internet protocol communications.

### BACKGROUND OF THE INVENTION

Session initiation protocol (SIP) is a protocol utilized to set up communications channels for communicating according to Internet protocol. One portion of the session initiation protocol involves the offer/answer model adopted by SIP (RFC3264). Another protocol associated with setting up Internet protocol communications is the session description protocol (SDP) (RFC2327). Originally, SDP was intended as a way of specifying media characteristics for the Mbone network. The offer/answer model of SIP places restrictions on SDP's use of SIP so that SDP offers sent by one user agent must be answered in order to have a valid SIP session establishment.

Two major offer/answer models are supported for SIP dialogue establishment. The first model is sometimes referred to as the “early offer” model. In it, the offer is placed in a SIP INVITE method. The answer is then returned in a 200 response or reliable provisional response, and the following ACK (acknowledgment) has no SDP. The second model called “delayed offer,” is often used by back-to-back user agents. Back-to-back user agents refer to a SIP based logical entity that can receive and process INVITE messages as a SIP user agent server (UAS). It also acts as a SIP user agent client (UAC) that determines how the request should be answered and how to initiate the outbound calls. In it, the initial INVITE contains no SDP. The offer then is passed in the 200 response or reliable provisional response, and the ACK contains the answer.

SDP convolves the specification of addresses and port numbers to be used for session establishment with the declaration of the session capabilities (CODECS, bit rates, video form-factors and frame rates, etc.). SDP is defined by the RFC2327 standard. An SDP offer or answer is typically embedded in a SIP message as a MIME-encoded body part.

### SUMMARY OF THE INVENTION

According to one embodiment of the invention, a method for use in establishing communications includes receiving an invitation for communication at a first device. The invitation for communication is devoid of video capability information. In response to receiving the invitation for communication, the method includes transmitting, from the first device, a signal other than an SDP signal. This signal includes multimedia capability information. After transmission of the signal, the first device receives an offer and incorporates the video capability information included in the signal.

According to another embodiment of the invention, a method for use in establishing communication includes receiving, from a first device, a signal other than an SDP signal. The signal includes multimedia capability information. In response to receiving the signal, the method includes transmitting, to the first device, an offer than incorporates the multimedia capability information.

Embodiments of the invention provide numerous technical advantages. Some, none, or all embodiments may benefit from the below described advantages. For example, according to one embodiment of the invention, a method is provided that allows a user agent to establish communications even in a back-to-back user agent environment without complicated SDP signaling. Further, such a method reduces the occurrence of failed attempts to establish communications sessions due to incompatibilities of certain protocols.

Other advantages will be readily apparent to one of skill in the art.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of a communication system according to the teachings of the invention;

FIG. 2 is a schematic diagram illustrating call invitation flow of the system of FIG. 1 according to conventional processing;

FIG. 3A is a flowchart illustrating a series of steps associated with initiating communications within the system of FIG. 1 according to the teachings of the invention; and

FIG. 3B is a schematic diagram illustrating a call initiation flow of a communication according to the flowchart of FIG. 3A.

### DETAILED DESCRIPTION OF THE INVENTION

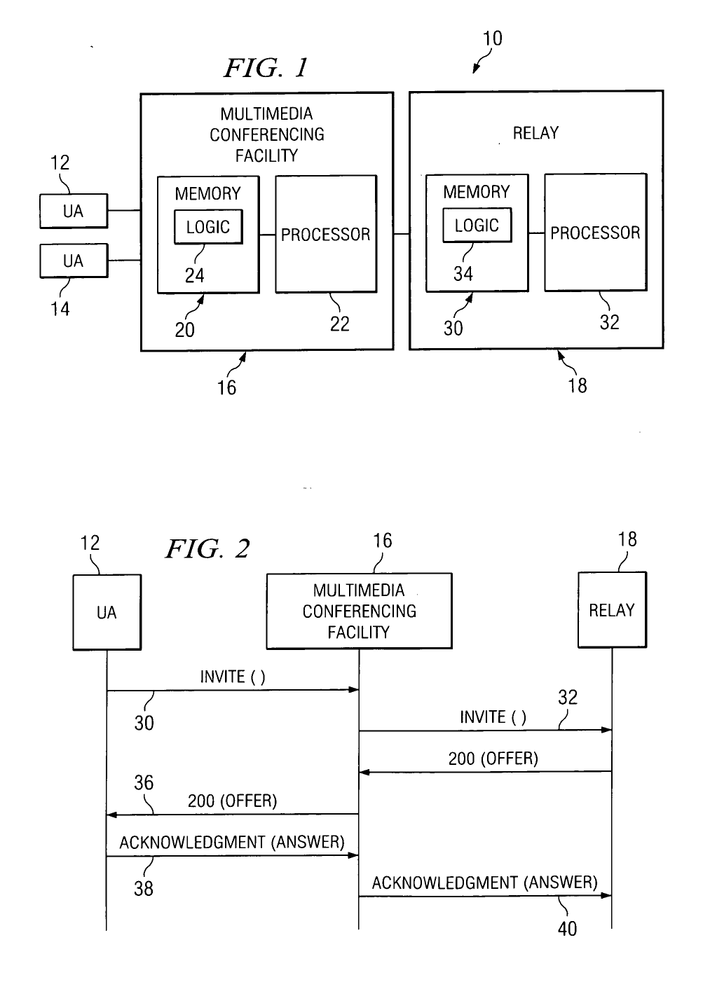

Embodiments of the present invention and its advantages are best understood by referring to FIGS. 1-3B of the drawings, like numerals being used for like and corresponding parts of the various drawings.

FIG. 1 is a block diagram illustrating a communication system 10 according to the teachings of the invention. Illustrated in system 10 are a user agent 12 and a user agent 14. User agents 12 and 14 are communicatively coupled to a back-to-back user agent acting as a multimedia conferencing facility 16. Also illustrated is a video media relay 18 associated with multimedia conferencing facility 16.

User agents 12 and 14 refer to Internet protocol devices that may be used in conjunction with a multimedia conferencing facility, such as an Internet protocol phone, video phone, or other suitable device. Multimedia conferencing facility 16 is one example of a back-to-back user agent. In this example the teachings of the invention are described in the context of a multimedia conferencing facility, although other back-to-back user agents may be used. Multimedia conferencing facility 18 operates in general to connect user agents 12 and 14 through audio and video IP communications. Video relay 18 is a device that can distribute video media throughout a multiconferencing network. Note that while audio media are typically mixed in a multimedia conference, the Video relay merely switches various media according to policies requested by the multimedia conferencing facility 16.

In one embodiment, multimedia conferencing facility 16 includes a computer-readable memory 20 associated with a processor 22. Logic 24 stored in memory 20 may be executed on processor 22 to perform the functions of multimedia conferencing facility 16, including those described herein. Memory 20 and processor 22 may take any suitable form, including conventional and yet-to-be developed memories and processors. Similarly, relay 18 may include, in one embodiment, a computer-readable memory 30 associated with a processor 32. Logic 34 stored in memory 30 may be executed on processor 32 to perform the functions of relay 18, including those described herein. Memory 30 and processor 32 may take any suitable form, including conventional and yet-to-be developed memories and processors.

The teachings of the invention recognize that in the context of system 10 in which one or more of user agent 12 and user agent 14 wish to connect using a delayed offer to a back-to-back user agent 16, which in this example is a multimedia conferencing facility, that is also associated with a video relay 18, that conventional use of SDP offers may be problematic. This is described in greater detail below in conjunction with FIG. 2.

FIG. 2 is a call flow diagram illustrating the expected flow of a SIP session that is attempting to set up communication between user agent 12 and the multimedia conferencing facility 16 using a delayed offer methodology. The convolution of the specification of addresses and port numbers by SDP to be used for session establishment with the declaration of the session capabilities (CODECS, bit rates, video form-factors, and brain rates, etc.) works well for the early offer model, and usually works for the delayed offer model. However, the teachings of the invention recognize that problems arise when the user agent 12 attempts to use the delayed offer model and one of the devices in the communication chain is a media relay, such as video relay 18, sometimes referred to as an IP-to-IP gateway.

Because media relays do not encode media, they often do not have enough information to specify media capabilities. At the same time, the media relay must be able to generate addresses and port numbers in its SDP, which implies that it must also generate media capability information. With reference to FIG. 2, below is a description of a specific case where this is problematic.

At step 30, a user agent 12 transmits a delayed offer invite to multimedia conferencing facility 16. Because the invite is a delayed offer invite it includes no SDP containing media capabilities or address information associated with the communication to be established. At step 32, according to SIP protocol, the delayed offer invite is forwarded to relay 18, also as a delayed offer, i.e., without an SDP. This is because the multimedia conferencing facility 16 is seeking to obtain the media capability and address information that would normally form a part of the SDP from another user agent. However in this case, because a relay is involved, the invite is sent directly to relay 18, but this is problematic.

What should occur is at step 34 a valid offer containing valid SDP must be returned in a 200 SIP message. However, in order to do so, relay 18 must provide the address and port information associated with the communication to be established as well as the media capabilities associated with the communication to be established. But, because relay 18 does not typically possess media capabilities, it has no media capabilities to return in a valid SDP as part of a 200 SIP response. Thus, the process flow breaks down at this point and communications with user agent 12 are not established. If communication had not broken down, at step 36, multimedia conferencing facility 16 would have forwarded the valid offer to user agent 12, which would then acknowledge the offer and provide an answer at step 38. This acknowledgment would then be forwarded on to relay 18 at step 40.

The teachings of the invention recognize that the main reason this communication breaks down is that multimedia conferencing facility 16 cannot contain port or address information on behalf of relay 18 and that relay 18 does not maintain media capabilities. This is problematic because an SDP requires both of these components to be part of a valid offer. However, the teachings of the invention recognize that although multimedia conferencing facility 16 does not have knowledge of port or address information, it does have media capability information. Further, although video relay 18 does not possess media capability information, it does have port and address information. Thus, according to the teachings of the invention, a mechanism is provided that allows aggregation of both multimedia conferencing capabilities as well as port and address information from each of the multimedia conferencing facility 16 and the relay 18 such that they may be used together.

The teachings of the invention also recognize that, according to SIP protocol, any SIP message that is not an answer that includes an SDP is considered an offer, which must be responded to with an answer. Thus, in the specific SIP embodiment, it would be difficult to transmit media capability of multimedia conferencing facility 16 within an SDP body part contained by a SIP invite, because this would require relay 18 to provide an answer. This would not be desirable because that offer would not include correct port and address information, which are unknown to multimedia conferencing facility 16.

One method for effecting this aggregation of port and address information with media capability information while being able to communicate within the SIP protocol (which is not required in all embodiments) is to create an INVITE that has a body part that is similar to SDP but that is not an SDP body part. By not being an SDP body part, media capability information known by multimedia conferencing facility 16 may be communicated to relay 18 as part of a SIP invite, but without requiring relay 18 to respond with an answer (which it could not because the offer would not include valid port and address information with the INVITE). Media capability information is one example of SDP body part information, or information that is normally included in an SDP body part. Other examples include session information, including bandwidth restrictions, and directionality information. In one example this SDP body part information may be encoded as SIP header information.

In one specific implementation, rather than transmitting an SIP INVITE with a valid SDP body part, the INVITE is transmitted with an SDP template, which in a specific implementation uses dummy port address information. The Multi-part Internet Mail Extension (MIME) type of the SDP template, is set to a type other than that assigned to SDP, such that the INVITE conforms to the delayed offer model instead of the early offer model. Compliance with the delayed offer model is important because relay 18 is then free to respond with an offer having a valid SDP. Use of a non-SDP MIME type allows the characteristics of the offer to be changed such that the offer does not require port and address information. In essence, a two-way handshake is changed to a three-way handshake, utilizing media capability information from multimedia conferencing facility 16 and port and address information from relay 18. Relay 18 then supplies port information of where to send media in a valid offer in response to the invite.

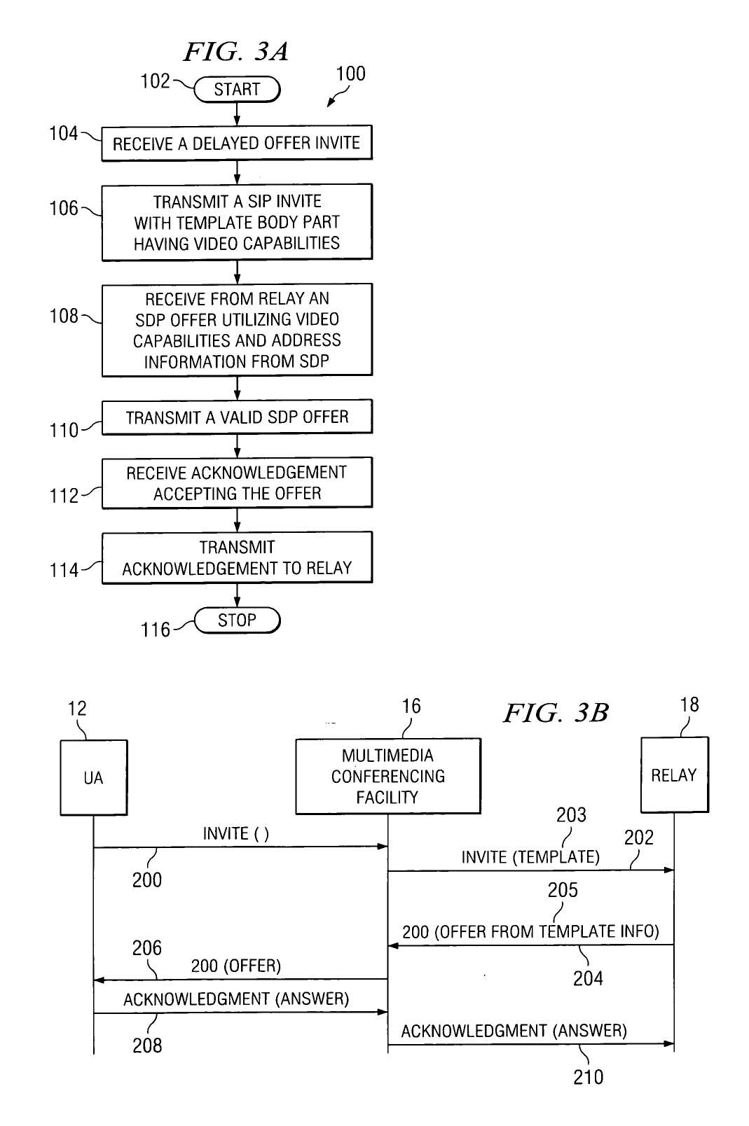

A specific implementation is illustrated in FIGS. 3A and 3B. FIG. 3A is a flowchart illustrating an example process on a back-to-back user agent for establishing communication according to the teachings of the invention, and FIG. 3B is a flow diagram showing initiation of a call according to the teachings of the invention.

The method 100 begins at step 102. At step 104 a delayed offer INVITE is received at a device. This delayed offer invite may be transmitted from a user agent such as user agent 12 to a back-to-back user device, which in this example is a multimedia conferencing facility 16. The sending of this invite is illustrated in FIG. 3B at reference numeral 200. As described above, the delayed offer invite does not include SDP, as indicated by the empty parenthesis in FIG. 3B. The SDP would normally include multimedia conferencing capability information as well as address information specifying the address and port number IP to which communications should be sent or the established communication. Although this particular implementation illustrates the delayed offer invite being a SIP delayed offer invite, in general any signal may be transmitted that constitutes an invitation for communication.

At step 106, a second delayed offer SIP invite is transmitted from multimedia conferencing facility 16 to relay 18. The sending of this invite is illustrated at reference numeral 202 in FIG. 3B. This SIP invite has a body part with an SDP template 203 (FIG. 3B) but the body part of this SIP invite is not SDP. In particular, the MIME type of the body part 203 is set to type other than SDP and therefore does not constitute an offer. However, the template 203 includes media capability information associated with multimedia conferencing facility 16. In a particular implementation, the body part includes one or more media types and one or more CODEC definitions. In general, multimedia conferencing facility 16 may be able to accommodate a plurality of types of media capabilities but may conventionally suggest certain capabilities that are likely to be amenable to a plurality of user agents. Thus, multimedia conferencing facility 16 has knowledge of which media capabilities it can process and which media capabilities are likely to be desired by user agents associated with it. Therefore, multimedia conferencing facility 16 may include in the SDP template 203 in the SIP invite this multimedia conferencing capability information.

In one particular implementation, template 203 has the same syntax as an SDP body part, even though it has a different MIME type. This implies that it also includes a fake IP address and port number that would normally indicate the IP address and port number to which communications should be sent once the communication channels are set up. However, in this instance, this IP address and port number are fake IP addresses and port numbers. In a particular implementation, this is performed for ease of use with existing equipment designed to parse SDP syntax containing port and address information; however, it is not necessary that a fake IP address or port number be provided in all embodiments. Further, it is not necessary that the invitation sent from multimedia conferencing facility 16 to relay 18 be a SIP invite. Rather, it is significant only that this signal is other than an SDP signal and that it includes media capability information.

At step 108, relay 18 transmits an offer from relay 18 to multimedia conferencing facility 16. In one particular implementation this offer is a valid SDP offer embedded within a SIP response message with response code 200(OK). This offer 205 (FIG. 3B) for communications includes all or some of the media capabilities transmitted at step 106 from multimedia conferencing facility 16 in SDP template 203. In one particular implementation, the SDP includes the one or more media types and the one or more CODEC definitions previously received from multimedia conferencing facility 16. In addition, this SDP is syntactically correct, including internet address and port information designating the location to which communication should be sent once established. This address and port information is provided by relay 18, because relay 18 knows the port and address information to which communications should be sent. The transmission of an offer within a SIP response message with response code 200(OK) is also illustrated in FIG. 3B as noted by reference number 204. In other implementations, the offer need not be a SIP SDP offer nor embedded in a SIP message but rather simply an offer that includes the multimedia conferencing capability information received in the signal previously received at relay 18.

At step 110 a valid SDP offer is transmitted to the user agent 12, as designated by reference numeral 206 in FIG. 3B, as an SIP 200 message, in this embodiment. In some implementations, the offer 206 has media capabilities that are compatible with the offer 204 received from the relay 18. Furthermore, the internet address and port information for video media in the offer 206 are identical to that received in the offer 204. This ensures that the video media will flow directly from the user agent 12 to the relay 18. In other implementations, offers other than SIP, SDP offers, and those embedded in SIP messages may be utilized. At step 112, multimedia conferencing facility 16 receives an ACK message with an SDP answer, in this embodiment, accepting the offer, which is also designated at step 208 of FIG. 3B. Finally, at step 114 this ACK message, also with an SDP answer, is forwarded to relay 18, as indicated by reference numeral 210 in FIG. 3B. The method concludes at step 116.

In other embodiments, the SIP response message 204 may contain a response code other than 200 OK. The offer may also be provided in any reliable provisional response, such as 180 (ringing) or 183 (call progress). If a reliable provisional response is used, the call flow may be altered so that the answer will be carried in a provisional acknowledgement (PRACK) method, conforming to procedures laid out in RFC 3262, in some embodiments.

It is noted that although FIGS. 3A and 3B refer to transmitting a SIP invite in response to receipt of a delayed offer invite, in some embodiments such transmission of a SIP invite (or SIP update) may occur without receipt of a delayed offer invite, or other initiating signal. Rather, multimedia conferencing facility 16 may act to initiate communication, with only the right hand side of FIG. 3B being effected, without communication with user agent 12. In this embodiment, only steps 106, 108, and 114 are performed without steps 104, 110, and 112.

Although some embodiments of the present invention have been described in detail, it should be understood that various changes, substitutions, and alterations can be made hereto without departing from the spirit and scope of the invention as defined by the appended claims.

What is claimed is:

1. A method for communication using Session Initiation Protocol (SIP) comprising:
receiving, at a multimedia conferencing facility, a delayed offer invite from a first device;
in response to receiving the delayed offer invite, transmitting a SIP invite to a media relay, the SIP invite comprising a body part with a Multi-Purpose Internet Mail Extension (MIME) type other than Session Description Protocol (SDP) and comprising a body part including one or more media types and one or more CODEC definitions but not comprising a valid internet protocol (IP) address for the invite; and
in response to transmitting the SIP invite comprising a body part with a MIME type other than SDP and that does not include a body part that comprises a valid IP address for the invite, receiving from the relay a valid SDP offer that comprises the one or more media types and the one or more CODEC definitions and that also comprises a valid IP address and a port number to which communications established through acceptance of the offer may be sent.

2. The method of claim 1, wherein the SIP invite includes a body part comprising a fake IP address for the SIP invite.

3. The method of claim 1, and further comprising transmitting, from the multimedia conferencing facility, the valid SDP offer to the first device.

4. The method of claim 3, and further comprising receiving, at the multimedia conferencing facility, an answer accepting the transmitted SDP offer.

5. An apparatus for use in establishing communications comprising:
computer-readable media; and
logic encoded on the computer-readable media operable, when executed on a processor, to:
receive, at a multimedia conferencing facility, a delayed offer invite from a first device;
in response to receipt of the delayed offer invite, transmit a Session Initiation Protocol (SIP) invite to a relay, the SIP invite comprising a Multi-Purpose Internet Mail Extension (MIME) type other than Session Description Protocol (SDP) and comprising a body part comprising one or more media types and one or more CODEC definitions but not comprising a valid internet protocol (IP) address for the invite; and
in response to transmission of the SIP invite comprising a body part comprising a MIME type other than SDP and that does not comprise a body part that comprises a valid IP address for the invite, receive from the relay a valid SDP offer that comprises the one or more media types and the one or more CODEC definitions and that also comprises a valid IP address and a port number to which communications established through acceptance of the offer may be sent; and
transmit the valid SDP offer to the first device.

6. The apparatus of claim 5, wherein the SIP invite comprises a body part comprising a fake IP address for the SIP invite.

7. The apparatus of claim 5, wherein the logic is further operable to transmit the valid SDP offer to the first device.

8. The apparatus of claim 5, wherein the apparatus comprises a multimedia conferencing facility.

9. A method for communication using the Session Initiation Protocol (SIP) comprising:
receiving, at a user agent server, from a multimedia conferencing facility, a SIP invite comprising a body part comprising a Multi-Purpose Internet Mail Extension (MIME) type other than Session Description Protocol (SDP) and comprising one or more media types and one or more CODEC definitions but not comprising a valid IP address for the SIP invite; and
in response to receiving the SIP invite comprising a body part comprising a MIME type other than SDP and comprising one or more media types and one or more CODEC definitions but not comprising a valid IP address for the SIP invite, transmitting, from the user agent server to the video conferencing facility, a valid SDP offer that comprises the one or more media types and the one or more CODEC definitions and that also comprises an internet protocol (IP) address and a port number to which communications established through acceptance of the offer may be sent.

10. The method of claim 9, wherein the body part comprises a fake IP address for the invite.

11. The method of claim 9, and further comprising generating, by the relay, the IP address and port number to which communications established through acceptance of the offer may be sent.

12. An apparatus comprising:
computer-readable media; and
logic encoded on the computer-readable media operable, when executed on a processor, to:
receive from a multimedia conferencing facility, a Session Initiation Protocol (SIP) invite comprising a body part comprising a Multi-Purpose Internet Mail Extension (MIME) type other than Session Description Protocol (SDP) and comprising one or more media types and one or more CODEC definitions, but not comprising a valid internet protocol (IP) address for the SIP invite; and
in response to receipt of the SIP invite comprising a body part comprising a MIME type other than SDP and comprising one or more media types and one or more CODEC definitions but not comprising a valid IP address for the SIP invite, transmit, from the relay to the multimedia conferencing facility, a valid SDP offer that comprises the one or more media types and the one or more CODEC definitions and that also comprises an IP address and a port number to which communications established through acceptance of the offer may be sent.

13. The apparatus of claim 12, wherein the SIP invite comprises a body part comprising a fake IP address for the SIP invite.

14. The apparatus of claim 12, wherein the apparatus comprises a video relay.

15. A method for use in establishing communications according to Session Initiation Protocol (SIP) comprising:
transmitting, from a first device, a SIP invite or update being devoid of an Session Description Protocol (SDP) body part, but comprising SDP body part information other than port and internet protocol (IP) address information; and
after transmitting the SIP invite or update, receiving at the first device a valid SIP offer that complies with the SDP body part information.

16. The method of claim 15, wherein transmitting a SIP invite or update comprises transmitting a SIP invite or update in response to receiving an invitation for communication at the first device, the invitation being devoid of SDP body part information other than port and IP address information.

17. The method of claim 15, wherein the SDP body part information is encoded as a Multi-Purpose Internet Mail Extension (MIME) body part with a MIME type different than an SDP MIME type.

18. The method of claim 17, wherein the MIME body part has an SDP syntax that is parseable by an SDP parser.

19. The method of claim 15, wherein the SDP body part information is encoded as SIP header information.

20. The method of claim 15, wherein the first device comprises a multimedia conferencing facility.

21. The method of claim 15, wherein the SIP invite or update comprises one or more CODEC definitions but does not include a valid IP address for the invite.

22. The method of claim 15, wherein the valid SIP offer comprises an IP address and a port number to which communications established through acceptance of the offer may be sent.

23. The method of claim 15, wherein the SIP invite or update comprises a SIP delayed offer invite.

24. The method of claim 15, wherein the valid SIP offer comprises SDP information derived from the SDP body part information included in the SIP invite or update.

25. An apparatus comprising:
computer-readable media; and
logic encoded on the computer-readable media operable, when executed on a processor, to:
transmit a Session Initiation Protocol (SIP) invite or update being devoid of an Session Description Protocol (SDP) body part, but comprising SDP body part information other than port and internet protocol (IP) address information; and
after transmitting the SIP update or invite, receive a valid SIP offer that complies with the SDP body part information.

26. The apparatus of claim 25, wherein the logic is further operable to receive an invitation for communication, the invitation for communication being devoid of video capability information.

27. The apparatus of claim 25, wherein the SDP body part information is encoded as a Multi-Purpose Internet Mail Extension (MIME) body part with a MIME type different than an SDP MIME type.

28. The apparatus of claim 25, wherein the MIME body part has an SDP syntax that is parseable by an SDP parser.

29. The apparatus of claim 25, wherein the SDP body part information is encoded as SIP header information.

30. The apparatus of claim 25, wherein the apparatus comprises a multimedia conferencing facility.

31. The apparatus of claim 25, wherein the SIP update or invite includes one or more CODEC definitions but does not include a valid IP address for the invite or update.

32. The apparatus of claim 25, wherein the valid SIP offer comprises an IP address and a port number to which communications established through acceptance of the offer may be sent.

33. The apparatus of claim 26, wherein the invitation for communication comprises a SIP delayed offer invite.

34. A method for use in establishing communication comprising:
receiving, from a first device, a Session Initiation Protocol (SIP) invite or update being devoid of an Session Description Protocol (SDP) body part, but comprising SDP body part information other than port and internet protocol (IP) address information; and
in response to receiving the SIP invite or update, transmitting, to the first device, a valid SIP offer that complies with the SDP body part information.

35. The method of claim 34, wherein the SDP body part information is encoded as a Multi-Purpose Internet Mail Extension (MIME) body part with a MIME type different than an SDP MIME type.

36. The method of claim 35, wherein the MIME body part has an SDP syntax that is parseable by an SDP parser.

37. The method of claim 34, wherein the SDP body part information is encoded as SIP header information.

38. The method of claim 34, wherein the first device comprises a multimedia conferencing facility.

39. The method of claim 34, wherein the SDP body part information includes one or more media types and one or more CODEC definitions, but is devoid of a valid IP address for the SIP invite or update.

40. The method of claim 34, wherein the SIP invite or update includes an IP address and a port number to which communications established through acceptance of the offer may be sent.

41. An apparatus comprising:
computer-readable media; and
logic encoded on the computer-readable media operable, when executed on a processor, to:
receive, from a first device, a Session Initiation Protocol (SIP) invite or update being devoid of an Session Description Protocol (SDP) body part, but comprising SDP body part information other than port and internet protocol (IP) address information;
in response to receiving the SIP invite or update, transmit to the first device, a valid SIP offer that complies with the SDP body part information.

42. The apparatus of claim 41, wherein the SDP body part information is encoded as a Multi-Purpose Internet Mail Extension (MIME) body part with a MIME type different than an SDP MIME type.

43. The apparatus of claim 41, wherein the MIME body part comprises an SDP syntax that is parseable by an SDP parser.

44. The apparatus of claim 41, wherein the SDP body part is encoded as SIP header information.

45. The apparatus of claim 41, wherein the apparatus comprises a user agent server.

46. The apparatus of claim 41, wherein the first device comprises a multimedia conferencing facility.

47. The apparatus of claim 41, wherein the SIP invite or update comprises one or more media types and one or more CODEC definitions, but not comprising a valid IP address for the SIP invite.
